(19) United States
(12) Patent Application Publication
(10) Pub. No.: US 2013/0204976 A1
(43) Pub. Date: Aug. 8, 2013

(54) MEDICAL IMAGE MANAGEMENT SYSTEM AND MEDICAL IMAGE MANAGEMENT DEVICE

(71) Applicants: Satoshi Okuyama, Nasushiobara-shi (JP); Nobuyuki Konuma, Utsunomiya-shi (JP)

(72) Inventors: Satoshi Okuyama, Nasushiobara-shi (JP); Nobuyuki Konuma, Utsunomiya-shi (JP)

(73) Assignees: TOSHIBA MEDICAL SYSTEMS CORPORATION, OTAWARA-SHI, TOCHIGI-KEN (JP); KABUSHIKI KAISHA TOSHIBA, TOKYO (JP)

(21) Appl. No.: 13/499,272

(22) PCT Filed: Oct. 13, 2011
(86) PCT No.: PCT/JP11/05724

§ 371 Date: Mar. 29, 2012

(30) Foreign Application Priority Data
Oct. 25, 2010 (JP) 2010-238237

(51) Int. Cl. H04L 29/08

(52) U.S. Cl. CPC H04L 67/32
USPC 709/219

(57) ABSTRACT

A medical image management system includes a plurality of servers, a determination means, a forwarding-destination determination part, and a forwarding processing means. The plurality of servers each comprise a memory that stores medical images to which supplementary information is attached, and performs image processing on medical images instructed by a client. The determination means determines whether or not to forward medical images based on the free space required for the image processing and the free space in the memory of the server. The forwarding-destination determination part determines a forwarding destination server to which the medical images are forwarded. The forwarding processing means forwards the medical images used for the image processing to the server determined by the forwarding-destination determination part.

This application is based upon and claims the benefit of priority from Japanese Patent Application No. 2010-238237, filed Oct. 25, 2010; the entire contents of (all of) which are incorporated herein by reference.

### FIELD

Embodiments of the present invention are related to the technology for a medical image management system that executes multiple processes related to the generation and/or processing of medical images by distributing the processes to multiple servers.

### BACKGROUND

It has become possible to use medical applications that are operated on an application server from a client via a network. It has also become possible to establish environments in which multiple units of such application servers have been installed. In such an environment, it becomes possible to distribute multiple medical applications to multiple application servers to perform processing. Moreover, medical imaging devices with the functions of an application server are now also starting to be installed.

In an environment in which multiple application servers are installed, the functions executed by each application server are of various kinds. In such an environment, a provider that automatically switches the destination server in accordance with the details of the processing being executed is installed. Through this provider, the operator is able to connect the client with an application server that is capable of executing a desired application.

However, in such an environment, each application server is required to process a wide variety of medical images in accordance with requests from multiple clients. As a result, the storage area required for executing the processing becomes compressed, and there is a risk that the execution of processing such as the execution of applications and image acquisition may be inhibited.

Methods of preventing the compression of storage area include a method in which, when executing each process, medical images stored in the storage area are forwarded to another application server. However, the data volume of medical images is large and forwarding takes time. Therefore, if medical images are forwarded at the time of each processing, the execution of the processing is inhibited by this forwarding, causing the problem that it becomes difficult to seamlessly execute the processing.

### BRIEF DESCRIPTION OF THE DRAWINGS

FIG. 1 is a block diagram of a medical image management system according to a first embodiment.

FIG. 2 is an example of statistical information.

FIG. 3 is an example of management information.

FIG. 4 is a sequence diagram showing operations of the medical image management system according to the first embodiment.

FIG. 5 is a flowchart showing operations of the medical image management system according to the first embodiment.

FIG. 6 is a flowchart showing operations of the medical image management system according to the first embodiment.

FIG. 7 is a flowchart showing operations of the medical image management system according to the first embodiment.

FIG. 8 is a flowchart showing operations of the medical image management system according to the first embodiment.

FIG. 9 is a block diagram showing a medical image management system according to a second embodiment.

FIG. 10 is an example of statistical information.

FIG. 11 is a block diagram of a medical image management system according to a third embodiment.

FIG. 12 is a block diagram of a medical image management system according to a fourth embodiment.

FIG. 13 is a sequence diagram showing operations of the medical image management system according to the fourth embodiment.

FIG. 14 is a flowchart showing operations of the medical image management system according to the fourth embodiment.

### DETAILED DESCRIPTION

A first mode of the present embodiment is a medical image management system including multiple servers, a determination means, a forwarding-destination determination part, and a forwarding processing means. The multiple servers each include a memory that stores medical images to which supplementary information is attached, and performs image processing on the medical images instructed by a client. The determination means determines whether or not to forward the medical images based on the free space required for the image processing and the free space in the memory of the server. The forwarding-destination determination part determines the forwarding destination server for forwarding the medical images. The forwarding processing means forwards the medical images to be used for the image processing to the server determined by the forwarding-destination determination part.

Moreover, a second mode of the present embodiment is a medical image management system that includes multiple servers that each include a memory, and executes image processing for the medical images instructed by a client using the servers. The memory stores medical images to which supplementary information is attached. Moreover, the medical image management system includes a reservation management part, a determination means, and a forwarding processing means. The reservation management part accepts the details of the processing to be performed on the medical images as well as a reservation for that processing from the client. The determination means determines whether or not the free space in the memory of the first server scheduled to execute the processing due to the reservation is less than a prescribed amount of free space. If the determination means determines that the free space is insufficient, the forwarding processing means forwards at least part of the images stored in the first server to a second server as forwarding images.

Moreover, a third mode of the present embodiment is a medical image management system that includes multiple servers that each include a memory and a processing part, and executes multiple sets of processing for medical images instructed by a client by distributing the processing to the multiple servers. The memory stores medical images to which supplementary information including data volume is attached. The processing part performs image processing on the medical images. Moreover, the medical image management system includes a reservation management part, a condition management part, a determination means, a management information memory, a forwarding-destination determination part, and a forwarding processing means. By receiving reservation information including the details of processing to be performed on the medical images from the client, the reservation management part accepts reservations for the processing. The condition management part specifies a required amount of space for the memory to execute the processing for which the reservation management part has received a reservation. The determination means compares the free space in the memory of the server scheduled to execute the processing with the required space. Moreover, if the free space does not meet the required space, based on the supplementary information of each medical image stored in the memory of the scheduled server, the determination means specifies forwarding images to be forwarded to another server from among the medical images stored in the memory of the scheduled server. The management information memory stores management information including information indicating the free space in the memory of each server. The forwarding-destination determination part receives the supplementary information of the forwarding images, and collates the data volume of the forwarding images included in the received supplementary information with the free space in each server included in the management information. By performing the collation, the forwarding-destination determination part specifies a forwarding destination server capable of storing the forwarding images from among the multiple servers. The forwarding processing means forwards the forwarding images to the forwarding destination server specified by the forwarding-destination determination part.

Moreover, a fourth mode of the present embodiment is a medical image management system that includes multiple servers that each include a memory and a processing part, and that executes multiple sets of processing for medical images instructed by a client by distributing the processing to the multiple servers. The memory stores medical images to which supplementary information including data volume is attached. The processing part performs images processing on the medical images. Moreover, the medical image management system includes a management information memory, a forwarding-destination determination part, and a forwarding processing means. The management information memory stores management information including at least information indicating the free space in the memory of each server. The forwarding-destination determination part receives the supplementary information of the medical images, and collates the data volume of the medical images that is included in the supplementary information with the free space in each server that is included in the management information. By performing the collation, the forwarding-destination determination part specifies the server capable of storing the medical images as a forwarding destination server for the medical images. The forwarding processing means forwards the medical images to the forwarding destination server specified by the forwarding-destination determination part. Moreover, if the processing part creates new medical images as secondary images by performing image processing on the medical images, the forwarding processing means forwards the secondary images.

Moreover, a fifth mode of the present embodiment is a medical image management device connected to a medical image management system that includes multiple servers that each include a memory and a processing part, and that executes multiple sets of processing for medical images instructed by a client by distributing the processing to the multiple servers. The memory stores medical images to which supplementary information including data volume and data types is attached. The processing part performs image processing on the medical images. The provider includes a management information memory and a forwarding-destination determination part. The management information memory stores the free space in each server and the processing that each server is capable of executing as management information. The forwarding-destination determination part receives the medical images as supplementary information, and collates the supplementary information with the management information. By performing the collation, the forwarding-destination determination part specifies a forwarding destination server from among the multiple servers that is capable of storing and processing the medical images to which the supplementary information has been attached.

### First Embodiment

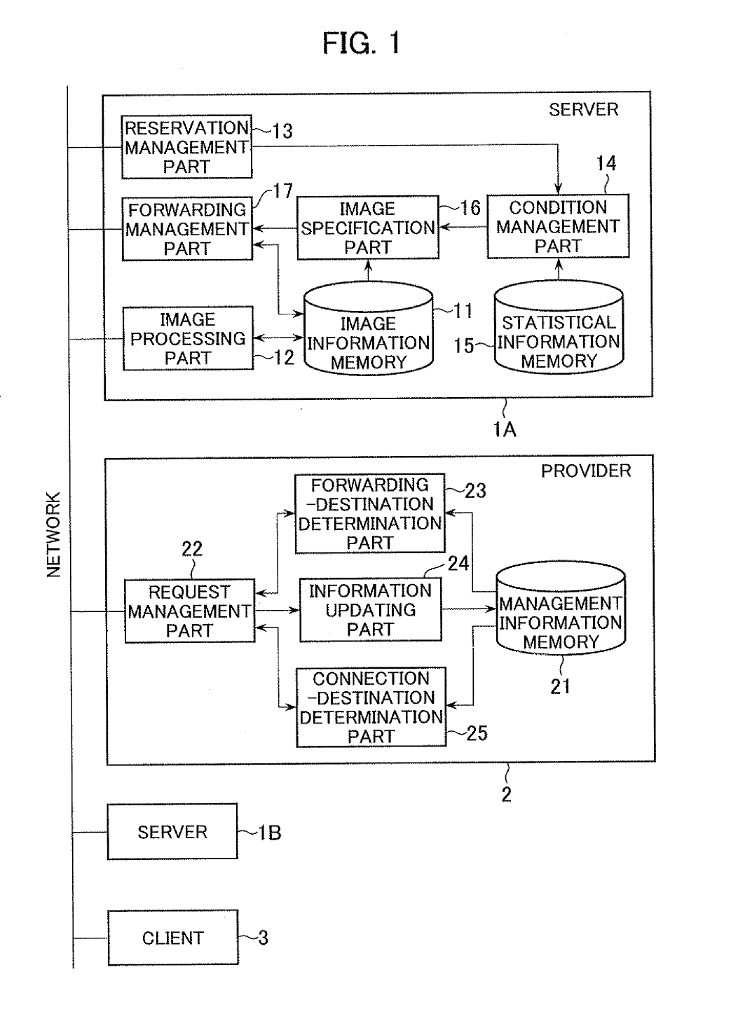

The configuration of a medical image management system according to the first embodiment will be described with reference to FIG. 1. The medical image management system according to the first embodiment is configured by multiple servers, a provider 2, and a client 3. In this medical image processing system, multiple sets of processing related to the generation and processing of medical images are distributed to multiple servers and executed. In the following, this medical image processing system will be described as including a server 1A, a server 1B, and a server 1C. Here, the server 1C is not shown in FIG. 1.

The configuration of each server will be described using the server 1A as an example. The server 1A includes an image information memory 11, an image processing part 12, a reservation management part 13, a condition management part 14, a statistical information memory 15, an image specification part 16, and a forwarding management part 17.

The image information memory 11 is a storage area that stores medical images. Supplementary information is attached to the medical image. The supplementary information includes information indicating attributes of the medical image. The information indicating the attributes of the medical image includes the data volume of the medical image, the data format, information indicating the date and time that the medical image was created or updated, and information on the instrument or application used to create the medical image, etc. The data format indicates the storage method of an image as data, or a data compression method, and is distinguished by the extension, for example. The information indicating the instrument or application used to create the medical image includes information indicating application names, modalities, manufacturer names, version information, and private tags, etc. Private tags refer to extension tags such as, for example, DICOM (Digital Imaging and COmmunication in Medicine) private tags. Information for specifying each medical image or information for associating the medical image with applications capable of processing this, etc. may be attached as attributes to these extension tags. It should be noted that the abovementioned information indicating data format and the information on the instrument or application used to create a medical image correspond to “data types”.

Based on an instruction from the client 3, the image processing part 12 executes an application related to interpretation processing or image processing, and performs either or both the generation and/or the processing of a medical image. In the following, processing related to either or both creating and/or processing a medical image is referred to simply as “image processing”. The following is a detailed description of operations of the image processing part 12. The image processing part 12 receives an instruction from the client 3 of image processing for a medical image together with a medical image to be processed. The image processing part 12 first reads out the medical image instructed by the client 3 from the image information memory 11. Next, by executing an application corresponding to the instruction from the client 3, the image processing part 12 performs image processing on the medical image that has been read out. If a new medical image is created due to the image processing, the image processing part 12 stores this medical image as a secondary image in the image information memory 11.

It should be noted that the details of the image processing that the image processing part 12 is capable of executing differ between the servers. Specifically, in each server, different applications are installed in accordance with the details of the image processing that the image processing part 12 of that server is capable of executing. The details of the processing that the image processing part 12 of each server is capable of executing are managed by the provider 2 that is described below.

The reservation management part 13 receives reservation information from the client 3. As a result, the reservation management part 13 accepts a reservation for image processing to be performed by the image processing part 12. The reservation information includes information for specifying the medical images to be processed, information indicating the processing details of the image processing (hereinafter referred to as “processing information”), and information indicating imaging conditions such as image resolution and count (number of slices), etc. The processing information includes, for example, the type of application for executing a desired image process, and information indicating functions that the application provides (types of partial image processing executed as part of a series of image processes).

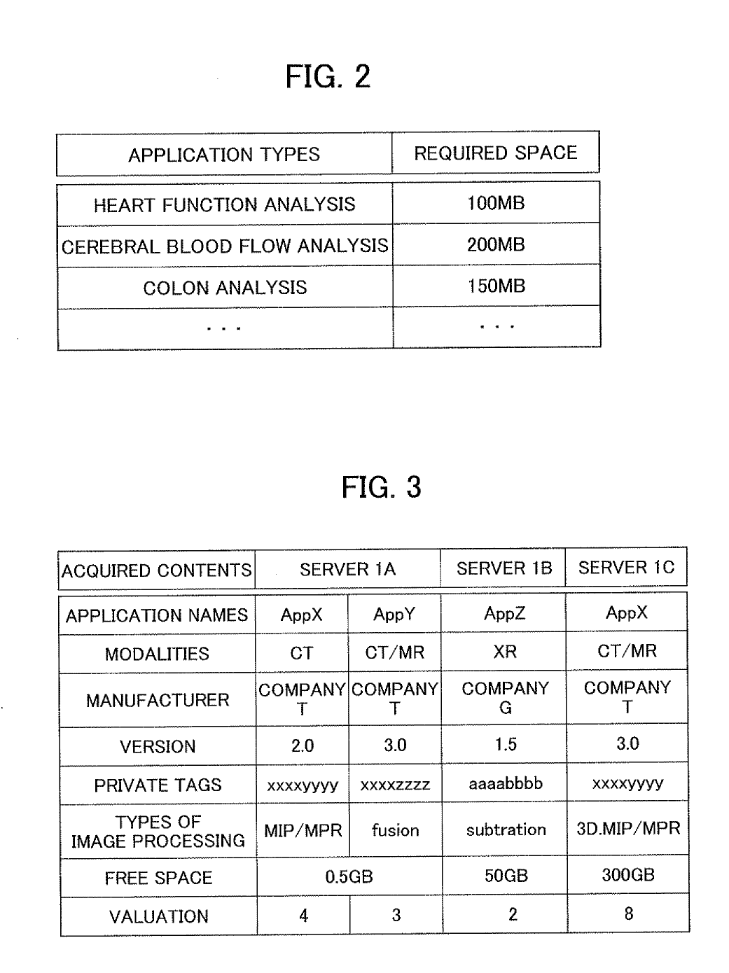

The statistical information memory 15 preliminarily stores statistical information. In the statistical information, the required space for executing each process is stored for each application type in accordance with the details of the image processing. Furthermore, the required space for executing each process indicates the capacity that is temporarily used for executing an application corresponding to the type, and required space for storing secondary images created as a result of the image processing. FIG. 2 shows an example of statistical information. As shown in FIG. 2, when executing an application for heart function analysis, for example, the fact that 100 MB of capacity is required is stored as statistical information. For the statistical information, it is good to calculate and store the required space for the execution of each process based on past experience. Moreover, the data volume subject to processing differs in accordance with the imaging conditions, and the required space for executing each process also changes in accordance with this data volume. Therefore, it is also possible to calculate statistical information corresponding to the imaging conditions and store this information in the statistical information memory 15. Moreover, it is also possible to calculate statistical information for each function provided by the application (i.e., for each type of partial image processing) and store this information in the statistical information memory 15. Moreover, it is also possible to combine the application type or the type of image processing provided by that application with the imaging conditions, calculate statistical information for each combination, and store this information in the statistical information memory 15.

When the reservation management part 13 accepts a reservation for image processing, the condition management part 14 specifies the required space for executing the reserved processing. Specifically, the condition management part 14 collates processing information and information indicating imaging conditions that are included in the reservation information received by the reservation management part 13 with the statistical information stored in the statistical information memory 15. As a result, the condition management part 14 specifies the required space for executing the processing indicated by the processing information based on the statistical information.

The image specification part 16 compares the required space obtained by the condition management part 14 with the free space in the image information memory 11. Furthermore, as one example, it is good if the image specification part 16 acquires the free space from the OS (Operating System). Moreover, the image specification part 16 may calculate the free space based on the total capacity of the image information memory 11 and the data volume of the medical images stored in the image information memory 11. If the free space in the image information memory 11 does not meet the required space, in order to secure the required space, the image specification part 16 specifies medical images to be forwarded to another server (hereinafter referred to as “forwarding images”) from the image information memory 11. Details of the process by which the image specification part 16 specifies the forwarding images are described below.

The image specification part 16 refers to supplementary information of each medical image stored in the image information memory 11, and specifies forwarding images in accordance with a predefined rule. As an example of the rule, the image specification part 16 specifies medical images that are not subject to processing by the image processing part 12 in the server itself as the forwarding images. In this case, the image specification part 16 collates information attached to each medical image on the data format and the instrument or application that created the medical image with the processing that the image processing part 12 is capable of executing. In this case, for each executable process, it is good to associate, manage and store the data types that each processing considers subject to processing. As a result of this collation, it becomes possible for the image specification part 16 to specify medical images that the image processing part 12 does not consider subject to processing. Moreover, as another example, the image specification part 16 specifies medical images that have not been updated for a fixed period as forwarding images. In this case, the image specification part 16 refers to information that is attached to each medical image and that indicates the time and date of updates, and searches for medical images for which a predefined period has passed since the last update. As a result of this search, it becomes possible for the image specification part 16 to specify medical images that have not been updated for a fixed period.

Moreover, the image specification part 16 receives an instruction from the forwarding management part 17, obtains the free space in the image information memory 17, and notifies the forwarding management part 17 with information indicating the obtained free space. It should be noted that the image specification part 16 corresponds to the “determination means”.

The forwarding management part 17 transmits the supplementary information of the forwarding images specified by the image specification part 16 to the provider 2, and inquires with the provider 2 regarding the server to which the forwarding images will be forwarded (hereinafter referred to as the “forwarding destination server”). As a response to this inquiry, the forwarding management part 17 is notified of the forwarding destination server by the provider 2. Upon receiving this notification, the forwarding management part 17 forwards the forwarding images to the forwarding destination server in the notification. When the forwarding of the forwarding images is complete, the forwarding management part 17 notifies the provider 2 of the completion of forwarding. At this time, the forwarding management part 17 transmits information for specifying the forwarding images together with information indicating the forwarding destination server to the provider 2. As a result, it becomes possible for the provider 2 to manage which image information memory 11 of which server each medical image is stored in. It should be noted that the server 1A (the forwarding source) in which the forwarding images are stored corresponds to the “first server”, and the above forwarding destination server corresponds to the “second server”.

Moreover, after the completion of the forwarding of the forwarding images, the forwarding management part 17 deletes the forwarded forwarding images from the image information memory 11. As a result, the free space in the image information memory 11 is increased. Subsequently, the forwarding management part 17 acquires information indicating the free space in the image information memory 11 from the image specification part 16. The forwarding management part 17 notifies the provider 2 of the acquired information indicating the free space. As a result, it becomes possible for the provider 2 to manage and store the free space in the image information memory 11 of the server 1A.

Moreover, if the forwarding management part 17 receives forwarding images from another server, it stores the received forwarding images in the image information memory 11. When the storage of the forwarding images in the image information memory 11 is complete, the forwarding management part 17 acquires information indicating the free space in the image information memory 11 from the image specification part 16. The forwarding management part 17 notifies the provider 2 of the acquired information indicating the free space and requests an update of the management information. As a result, the information that is managed and stored by the provider 2 and that indicates the free space in the image information memory 11 of the server 1A is updated. It should be noted that the forwarding management part 17 corresponds to the “forwarding processing means”.

Next, the configuration of the provider 2 is described. The provider 2 includes a management information memory 21, a request management part 22, a forwarding-destination determination part 23, an information updating part 24, and a connection-destination determination part 25. It should be noted that the provider 2 corresponds to the “medical image management device”.

The management information memory 21 stores management information for managing information on each server (e.g., servers 1A through 1C). The management information includes the application types that the image processing part 12 of each server is capable of executing, information on those applications, and information indicating the free space in the image information memory 11 of each server. The information on the applications includes, for example, application names, modalities, manufacturer names, version information, private tags, and information indicating the functions provided by that application (i.e., the types of partial image processing), etc. FIG. 3 shows an example of management information. As shown in FIG. 3, for example, the fact that the server 1A is capable of executing image processing provided as applications AppX and AppY is stored as management information. According to this management information, the application AppX installed in the server 1A defines medical images captured using the modality “CT” (i.e., CT images) as subjects for processing. Moreover, the application AppX is an application of “Company T”, and the version is “2.0”. Moreover, the application AppX is associated with the private tag “xxxxyyyy”. Moreover, the application AppX has the function of “MIP/MPR”. Moreover, this management information indicates that the free space in the image information memory 11 of the server 1A is 0.5 GB. Moreover, in the management information, it is good to associate and store the types of data subject to processing by the application for each application. Moreover, as with the server 1A, for the servers (e.g., servers 1B and 1C) also included in the medical image management system, the management information includes the above-mentioned information for each.

Moreover, the management information memory 21 associates information for specifying each medical image with information indicating the storage destination of that medical image (i.e., the image information memory 11 of the server in which it is stored) and stores it as image-storage-destination information. As a result of this image-storage-destination information, it is possible for the provider 2 to specify the server in which each medical image is stored.

From each server (servers 1A through 1C), the request management part 22 accepts inquiries regarding the forwarding destination server to which the forwarding images are forwarded, notifications of the completion of forwarding, and notifications of information indicating free space. Moreover, the request management part 22 accepts connection requests to the server from the client 3. In accordance with the details of the accepted information, the request management part 22 requests one of the forwarding-destination determination part 23, the information updating part 24, and the connection-destination determination part 25 to perform the processing. Operations of the request management part 22 are described in more detail below. Furthermore, the forwarding-destination determination part 23, the information updating part 24, and the connection-destination determination part 25 will be described below.

From each server (servers 1A through 1C), the request management part 22 receives inquiries regarding the forwarding destination server for forwarding the forwarding images, and the supplementary information of the forwarding images. In this case, the request management part 22 outputs the received supplementary information to the forwarding-destination determination part 23, and instructs the specification of the forwarding destination server to the forwarding-destination determination part 23. As a response to this instruction, the request management part 22 receives a notification of the forwarding destination server from the forwarding-destination determination part 23. As a response to a received inquiry regarding the forwarding destination server, the request management part 22 notifies the server (e.g., server 1A) that is the source of the request of the forwarding destination server. Furthermore, if there are multiple forwarding images, the request management part 22 may cause the forwarding-destination determination part 23 to operate to specify a forwarding destination server for each forwarding image. In this case, the request management part 22 notifies the server that is the source of a request, of the forwarding destination server for each forwarding image.

When a medical image stored in one server is forwarded to another server, the request management part 22 receives notification of the completion of forwarding from the server that is the forwarding source. In this case, the request management part 22 outputs the information for specifying the forwarding images and the information indicating the forwarding destination server, which are notified at the same time, to the information updating part 24, and instructs the updating of the image-storage-destination information to the information updating part 24. Upon receiving this instruction, the information updating part 24 updates the information included in the image-storage-destination information that indicates the storage destination of the forwarding images.

When the free space of the image information memory 11 of each server is updated, the request management part 22 receives notification of information indicating the free space from the server in which the free space has been updated. In this case, the request management part 22 outputs information indicating the server in which the free space has been updated and information indicating the notified free space to the information updating part 24, and instructs the updating of the management information to the information updating part 24. Upon receiving this instruction, the information updating part 24 updates the information included in the management information that indicates the free space in the server in which the free space has been updated.

The request management part 22 receives a request to connect to a server from the client 3. This connection request includes information for specifying images subject to processing and information indicating the details of processing to be executed. In this case, the request management part 22 outputs the connection request to the connection-destination determination part 25, and instructs the specification of a connection destination server to the connection-destination determination part 25. As a response to this instruction, the request management part 22 receives a notification of the connection destination server from the connection-destination determination part 25. The request management part 22 establishes a connection between the client 3, which is the source of the connection request, and the notified connection destination server. As a result, it becomes possible for the client 3 to transmit reservation information to each server or instruct the execution of image processing to each server. Furthermore, the request management part 22 may specify a connection destination server based on processing information included in the reservation information. As a result, it becomes possible for an operator to reserve processing in a server capable of executing desired processing without thinking of the connection destination server.

Together with the instruction from the request management part for the specification of a forwarding destination server, the forwarding-destination determination part 23 also receives the supplementary information of the forwarding images. The forwarding-destination determination part 23 collates the supplementary information of the forwarding images with information on each server that is included in the management information, and specifies the forwarding destination server. The processing by which the forwarding-destination determination part 23 specifies the forwarding destination server is described in detail below, with reference to an example.

The forwarding-destination determination part 23 collates information indicating the data volume of the forwarding images that is included in the supplementary information with information indicating the free space in each server that is included in the management information, and specifies a server capable of storing the forwarding images. Moreover, the forwarding-destination determination part 23 collates each information included in the information on the instrument or application that created the forwarding images with each information on applications (image processing) that each server is capable of executing, and specifies a server capable of processing the forwarding images. For example, if the private tags attached to the forwarding images and the private tags associated with the applications of each server match, the forwarding-destination determination part 23 specifies that server. Moreover, based on the data format of the forwarding images, a server in which an application capable of processing those forwarding images has been installed may be specified. The forwarding-destination determination part 23 may use any one of the above collations, or may combine all of these collations.

The forwarding-destination determination part 23 may execute multiple or all collations of the type described above, and assign points each time the information from each collation conforms. In this case, the forwarding-destination determination part 23 specifies the server to which the highest points have been assigned as the forwarding destination server. Moreover, weights may be set for the points assigned for each collation. As one example, it is good to set the weight for points assigned for collations between information indicating data volume and information indicating free space as the highest. Moreover, the same applies for collations between each information included in the information on the instrument or application that created the forwarding images with each information included in the management information on applications (image processing) that each server is capable of executing. As one example, it is good to set the weight for points from collations of private tags and, functions (i.e., types of partial image processing) high, and set the weight for points from collations of versions low. The forwarding-destination determination part 23 notifies the request management part 22 of the forwarding destination server specified based on the above collations.

Together with an instruction from the request management part 22 for an update of the image-storage-destination information, the information updating part 24 also receives information for specifying the forwarding images and information indicating the forwarding destination server. The information updating part 24 searches the image-storage-destination information stored in the management information memory 21, and specifies information for specifying the forwarding images. The information updating part 24 updates the storage destination associated with the specified information for specifying the forwarding images to the server of the forwarding destination received from the request management part 22. As a result, it becomes possible for the provider 2 to specify the storage destination after the forwarding of the forwarding images based on the image-storage-destination information.

Moreover, together with an instruction from the request management part 22 for an update of the management information, the information updating part 24 also receives information indicating a server in which the free space has been updated and information indicating the free space of that server. The information updating part 24 searches the management information stored in the management information memory 21, and specifies information corresponding to the server in the notification. From within the information corresponding to the specified server, the information updating part 24 updates the information indicating the free space to the information received from the request management part 22 indicating the free space of the server. As a result, it becomes possible for the provider 2 to specify, based on this management information, the free space after the updating of the server in which the free space has been updated.

Together with an instruction for an identification of a connection destination server, the connection-destination determination part 25 also receives a connection request from the client 3. The connection-destination determination part 25 collates the information included in the connection request that specifies the images subject to processing with the image-storage-destination information, and specifies the server in which the images subject to processing are stored as the connection destination server. Moreover, the connection-destination determination part 25 may collate the information included in the connection request that indicates the details of the processing to be executed with the information on each server that is included in the management information, and specify a server capable of executing the processing specified in the connection request as the connection destination server. The connection-destination determination part 25 notifies the request management part 22 of the connection destination server specified based on the above collations. Furthermore, if the images subject to processing are not stored in the server capable of executing the processing specified in the connection request, the server storing the images may be configured to operate to forward the images subject to processing to that server. In this case, it is possible to specify the server storing the images based on the image-storage-destination information.

The above has been a description of examples of securing capacity that is temporarily used for executing each image process, or securing the required space for storing secondary images created as a result of image processing, in the image information memory 11. However, a configuration may be provided in which these two types of capacity are secured in different storage areas. In this case, it is sufficient to store the required space in each storage area as statistical information for each process. Moreover, it is good to cause the image specification part 16 to operate to specify forwarding images from each region.

### (Operations)

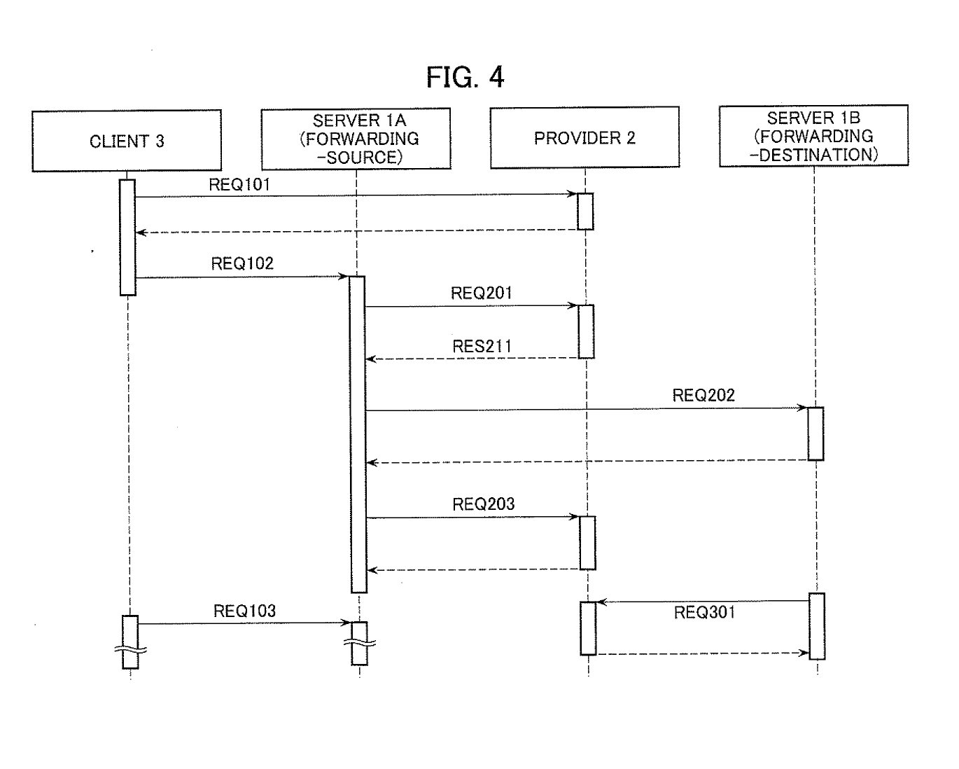

Next, a series of operations of the medical image management system according to the first embodiment will be divided into “acceptance of reservation”, “specification of forwarding destination”, and “forwarding of images”, and described with reference to FIG. 4 through FIG. 8. FIG. 4 is a sequence diagram of the medical image management system according to the first embodiment.

### (Acceptance of Reservation)

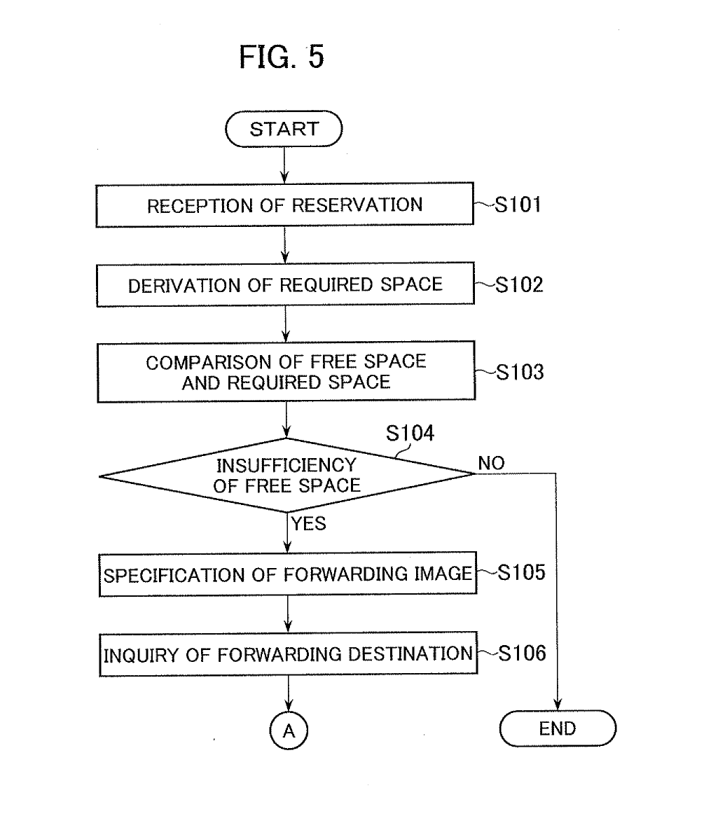

First, with regard to operations related to the acceptance of a reservation, an example in which the server 1A accepts a reservation for image processing from the client 3 will be described with reference to FIG. 4 and FIG. 5. FIG. 5 is a flowchart for describing operations of the server 1A when it accepts a reservation for image processing.

First, reservation information REQ101 including processing information indicating the details of image processing is transmitted from the client 3 to the request management part 22 of the provider 2. The request management part 22 outputs the reservation information REQ101 to the connection-destination determination part 25, and causes the connection-destination determination part 25 to specify a server capable of executing the image processing shown in the reservation information REQ101. For example, let us say that the application corresponding to the processing information of the reservation information REQ101 is the application AppX. In this case, based on the management information stored in the management information memory 21 (e.g., FIG. 3), the connection-destination determination part 25 specifies the server 1A, in which the application AppX has been installed, as the connection destination server. The request management part 22 establishes a connection between the server 1A specified by the connection-destination determination part 25 and the client 3. As a result, as shown in FIG. 4, reservation information REQ102 for image processing is transmitted from the client 3 to the server 1A. Next, operations of the server 1A after it receives the reservation information REQ102 will be described with reference to FIG. 5.

### (Step S101)

The reservation information REQ 102 transmitted from the client 3 is received by the reservation management part 13 of the server 1A. As a result, the reservation management part 13 accepts a reservation for image processing.

### (Step S102)

When the reservation is accepted by the reservation management part 13, the condition management part 14 collates the processing information included in this reservation information with statistical information stored in the statistical information memory 15. As a result of this collation, the condition management part 14 specifies the required space for executing the processing corresponding to the processing information. For example, let us say that the application AppX corresponding to the processing information is an application for cerebral blood flow analysis. In this case, the condition management part 14 specifies that the required space is 200 MB based on the statistical information (e.g., FIG. 2).

### (Step S103)

Next, the image specification part 16 compares the required space obtained by the condition management part 14 with the free space in the image information memory 11.

### (Step S104)

If the required space is smaller than the free space in the image information memory 11 (Step S104: N), the server 1A ends the processing related to the acceptance of the reservation.

### (Step S105)

If the free space in the image information memory 11 does not meet the required space (i.e., if the required space is larger than the free space) (Step S104: Y), the image specification part 16 specifies forwarding images from the image information memory 11. For example, if the processing information included in the reservation information corresponds to the application AppX, the image specification part 16 specifies medical images that the application AppX does not consider subject to processing as the forwarding images. Alternatively, the image specification part 16 may specify medical images that have not been updated for a fixed period as the forwarding images.

### (Step S106)

The forwarding management part 17 transmits the supplementary information of the forwarding images identified by the image specification part 16 to the provider 2, and sends an inquiry regarding the forwarding destination server to the provider 2. This supplementary information and inquiry transmitted to the provider 2 correspond to the inquiry REQ201 shown in FIG. 4.

### (Identification of Forwarding Destination)

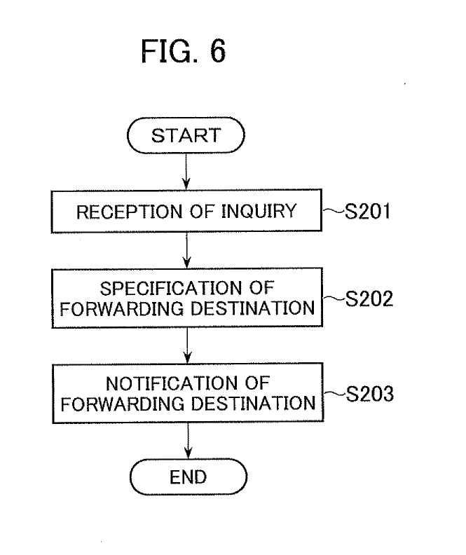

Next, operations of the provider 2 after it receives the inquiry REQ201 will be described with reference to FIG. 6. FIG. 6 is a flowchart for describing operations of the provider 2 for specifying the forwarding destination server based on the inquiry REQ201.

### (Step S201)

The inquiry REQ201 transmitted from the server 1A is received by the request management part 22 of the provider 2. Upon confirming that the inquiry REQ201 is an inquiry regarding the forwarding destination server, the request management part 22 outputs the supplementary information of the forwarding images that was also received to the forwarding-destination determination part 23, and instructs the specification of a forwarding destination server.

### (Step S202)

The forwarding-destination determination part 23 collates the supplementary information of the forwarding images with information on each server that is included in the management information stored in the management information memory 21, and specifies a forwarding destination server. For example, let us say that the supplementary information of the forwarding images indicates that the private tag is “aaaabbbb”. In this case, based on the management information (e.g., FIG. 3), the forwarding-destination determination part 23 specifies that the forwarding images are subject to processing by the application AppZ. As a result, the forwarding-destination determination part 23 specifies the server 1B, in which the application AppZ has been installed, as the forwarding destination server. Furthermore, instead of the private tag, the forwarding-destination determination part 23 may specify the forwarding destination server based on information indicating modalities or information indicating functions (i.e., types of partial image processing). In the following description, the server 1B has been identified as the forwarding destination server. The forwarding-destination determination part 23 notifies the request management part 22 of the server 1B identified based on the above collations.

### (Step S203)

The request management part 22 notifies the server 1A, which is the request source of the forwarding destination server, that the server 1B in the notification from the forwarding-destination determination part 23 is the forwarding destination server. This notification regarding the forwarding destination server corresponds to RES211 in FIG. 4.

### (Forwarding of Images)

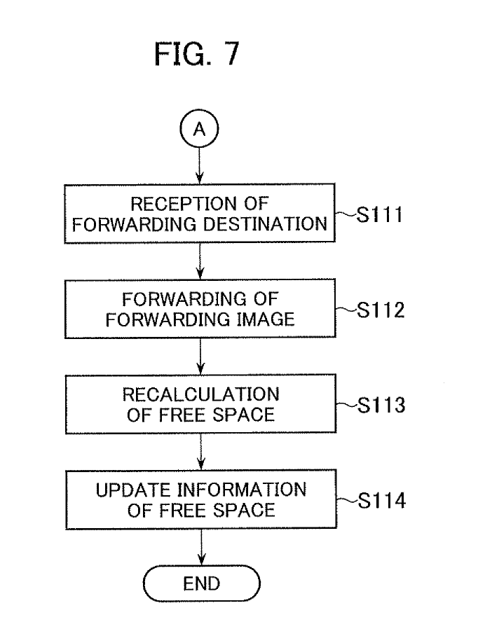

Next, operations of the server 1A after it has received the notification RES211 from the provider 2 will be described with reference to FIG. 7. FIG. 7 is a flowchart for describing operations when the server 1A forwards the forwarding images to the forwarding destination server.

### (Step S111)

The notification RES211 regarding the forwarding destination server from the request management part 22 is received by the forwarding management part 17 of the server 1A.

### (Step S112)

The forwarding management part 17 forwards the forwarding images to the server 1B indicated by the notification RES211. It should be noted that the forwarding images forwarded to the server 1B correspond to REQ202 in FIG. 4. Furthermore, operations of the server 1B after it receives the forwarding images REQ202 will be described later.

### (Step S113)

When the forwarding of the forwarding images is completed, the forwarding management part 17 deletes the forwarded forwarding images from the image information memory 11. As a result, the free space in the image information memory 11 is increased. Subsequently, the forwarding management part 17 acquires the information indicating the free space in the image information memory 11 from the image specification part 16.

### (Step S114)

Next, the forwarding management part 17 transmits the information for specifying the forwarding images and the information indicating the forwarding destination server to the provider 2, and notifies the provider 2 of the completion of forwarding. Moreover, the forwarding management part 17 notifies the provider 2 of the information indicating free space acquired from the image specification part 16. This notification of the completion of forwarding and the notification of the information indicating free space correspond to REQ203 in FIG. 4.

Upon receiving notification of the completion of forwarding from the server 1A, the request management part 22 outputs the information for specifying the forwarding images and the information indicating the forwarding destination server, which have been notified together, to the information updating part 24, and instructs an update of the image-storage-destination information. Upon receiving this instruction, the information updating part 24 updates the information indicating the storage destination of the forwarding images that is included in the image-storage-destination information. As a result, the storage destination of the forwarding images that is included in the image-storage-destination information is updated from the server 1A to the server 1B, which is the forwarding destination server. As a result, if a reservation is made for processing for the forwarding images, it becomes possible for the connection-destination determination part 25 to specify the server 1B, which is the forwarding destination server, as the connection destination server.

Moreover, upon receiving notification of the information indicating free space from the server 1A, the request management part 22 outputs the information indicating the server 1A and the notified information indicating free space to the information updating part 24, and instructs an update of the management information. Upon receiving this instruction, the information updating part 24 updates the information indicating the free space in the server 1A that is included in the management information.

As a result, the required space for executing the reserved image processing is secured in the image information memory 11 of the server 1A. Subsequently, the server 1A receives an instruction (REQ103 in FIG. 4) related to the execution of the reserved image processing from the client 3, and executes this image processing.

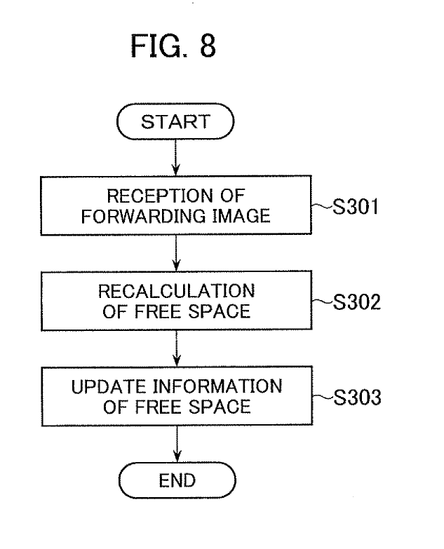

Next, operations of the server 1B after receiving the forwarding images REQ202 from the server 1A will be described with reference to FIG. 8. FIG. 8 is a flowchart for describing operations when the server 1B has received the forwarding images.

### (Step S301)

The forwarding images REQ202 transmitted from the forwarding management part 17 of the server 1A is received in the forwarding management part 17 of the server 1B.

### (Step S302)

The forwarding management part 17 of the server 1B causes the image information memory 11 to store the received forwarding images. When the storage of the forwarding images in the image information memory 11 has been completed, the forwarding management part 17 acquires information indicating the free space in the image information memory 11 from the image specification part 16.

### (Step S303)

The forwarding management part 17 of the server 1B notifies the provider 2 of the acquired information indicating the free space. This notification of the information indicating free space corresponds to REQ301 in FIG. 4. Upon receiving this notification REQ301, the request management part 22 of the provider 2 outputs information indicating the server 1B and the notified information indicating free space to the information updating part 24, and instructs an update of the management information. Upon receiving this instruction, the information updating part 24 updates the information that is included in the management information and that indicates the free space in the server for which a notification has been received.

According to the medical image management system according to the first embodiment described above, it becomes possible to preliminarily secure the required space for executing reserved processing before the processing is executed, based on reservation information for image processing. As a result, this prevents compression of the storage area required for each server to execute the processing. Moreover, because the required storage area is secured in advance, it becomes possible to prevent the occurrence of waiting time during operations caused by the forwarding of data for securing space.

### Second Embodiment

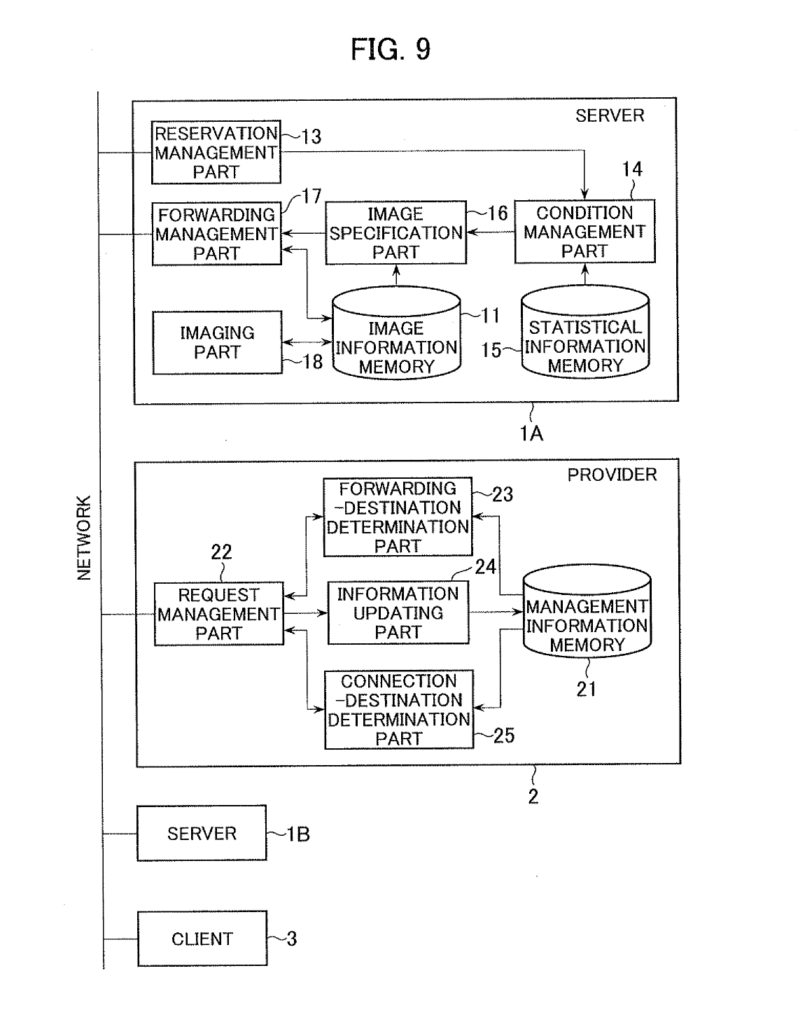

Next, the configuration of a medical image management system according to a second embodiment will be described with reference to FIG. 9. FIG. 9 is a block diagram of the medical image management system according to the present embodiment. The server 1A according to the present embodiment includes an imaging part 18 that captures medical images. The following description focuses on configurations different from the medical image management system according to the first embodiment.

The imaging part 18 has a configuration that captures medical images. Specific examples of the imaging part 18 include CT (Computed Tomography) and MRI (Magnetic Resonance Imaging system). Medical images captured by the imaging part 18 are stored in the image information memory 11.

By receiving reservation information from the client 3, the reservation management part 13 according to the second embodiment accepts a reservation for capturing of medical images by the imaging part 18. Reservation information related to the capture of medical images includes, as processing information, information indicating imaging conditions.

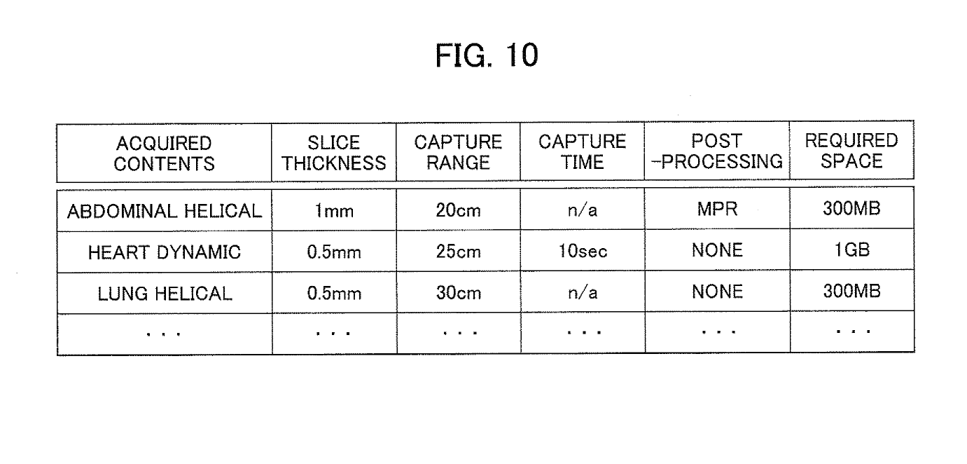

In accordance with the imaging conditions, the statistical information memory 15 according to the second embodiment preliminarily stores the required space for executing image capture as statistical information. FIG. 10 shows one example of statistical information indicating the required space in accordance with the imaging conditions. As shown in FIG. 10, if image capture is performed by setting the imaging conditions to “abdominal helical”, a slice thickness of “1 mm”, a capture range of “20 cm”, and “MPR” for post-processing, the fact that a capacity of 300 MB is required is stored as statistical information. For this statistical information, it is good to calculate and store the required space for executing each process based on past experience.

Once the reservation management part 13 accepts a reservation for image capture, the condition management part 14 specifies the required space for the reserved image capture. Specifically, the condition management part 14 collates the processing information included in the reservation information received by the reservation management part 13 with the statistical information stored in the statistical information memory 15. As a result, the condition management part 14 specifies the required space for executing image capture in accordance with the processing information.

Subsequent operations of the image specification part 16 and the forwarding management part 17 are similar to those of the medical image management system according to the first embodiment. In other words, the image specification part 16 compares the required space obtained by the condition management part 14 with the free space in the image information memory 11. If the free space does not meet the required space, the image specification part 16 specifies forwarding images to forward to another server to secure the required space. The forwarding management part 17 sends an inquiry regarding the forwarding destination server to the provider 2, and forwards the forwarding images to the forwarding destination server in the notification, thereby the required space for executing the reserved image capture is secured.

According to the medical image management system according to the present embodiment, it becomes possible to preliminarily store the required space for executing a reserved image capture before the image capture is executed, based on the reservation information for the image capture. In other words, it becomes possible to obtain effects similar to those of the first embodiment even for the capture of medical images.

### Third Embodiment

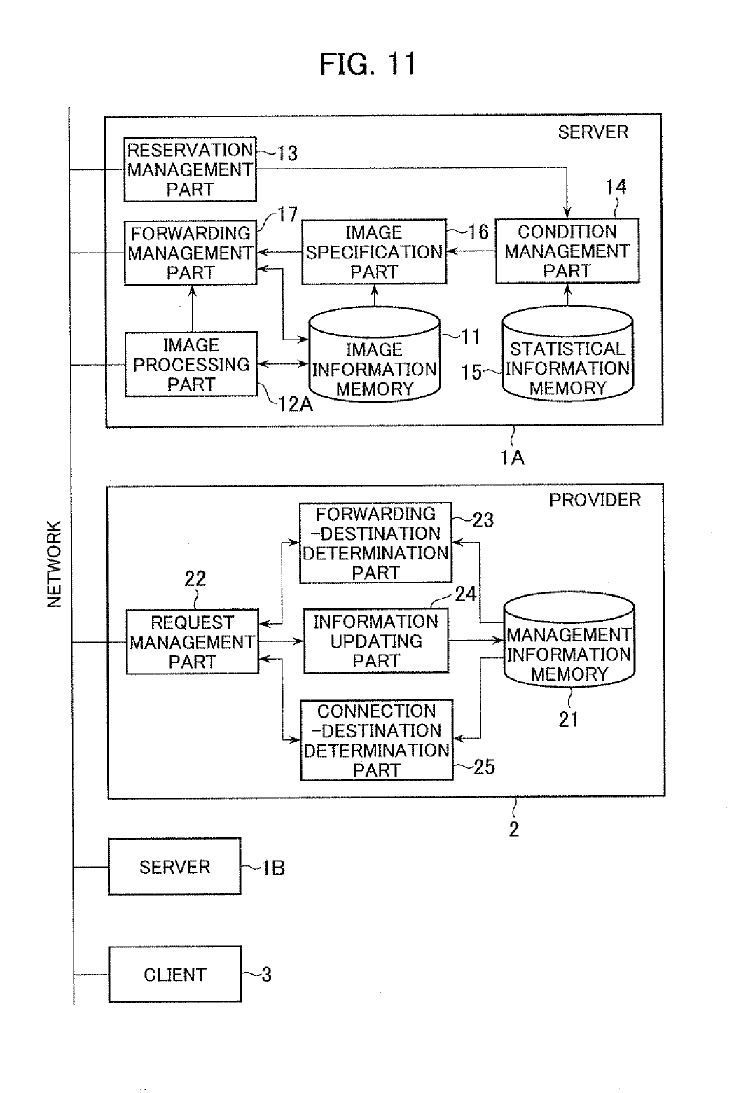

If executing multiple processes related to the generation and processing of medical images by distributing these processes to multiple servers, it is not necessarily the case that secondary images created by the image processing part of each server can be processed by the image processing part of that server. In such a case, even though the secondary images are not subject to processing by that server, they are stored in the image information memory 11 of that server. As a result, those secondary images may become a cause of compression of the image information memory 11 of that server. In a medical image management system according to a third embodiment, regardless of whether there is a reservation for image processing, if secondary images created by the image processing part are not subject to image processing executed by that server, they are forwarded to a server capable of processing those secondary images. In the following, the configuration of the medical image management system according to the present embodiment will be described with reference to FIG. 11, with a focus on configurations different from those of the medical image management system according to the first embodiment. FIG. 11 is a block diagram showing the medical image management system according to the present embodiment.

By executing an application corresponding to an instruction from the client 3, the image processing part 12A performs image processing for the instructed medical images. If a new medical image is created as a result of the image processing, the image processing part 12A stores this medical image as a secondary image in the image information memory 11. These operations are similar to those of the image processing part 12 according to the first embodiment.

If a secondary image is created, the image processing part 12A collates the data format attached to the secondary image and information on the instrument or application that created the secondary image, with the processes that it (the image processing part 12A) is capable of executing. If the secondary image is a medical image that is not subject to processing performed by itself (the image processing part 12A), the image processing part 12A specifies the secondary image as a forwarding image.

The forwarding management part 17 transmits the supplementary information of this forwarding image to the provider 2, and sends an inquiry to the provider 2 regarding the forwarding destination server. Subsequent operations are similar to those of the medical image management system according to the first embodiment.

According to the medical image management system according to the present embodiment as described above, regardless of whether there is a reservation for image processing, if the image processing part 12A creates a secondary image that is not subject to processing performed by itself, it specifies the secondary image as a forwarding image. The identified secondary image is forwarded to a server capable of processing it by the forwarding management part 17. As a result, it becomes possible to preliminarily prevent compression of the image information memory 11 of the server caused by the accumulation of medical images that are not subject to processing performed by that server.

### Fourth Embodiment

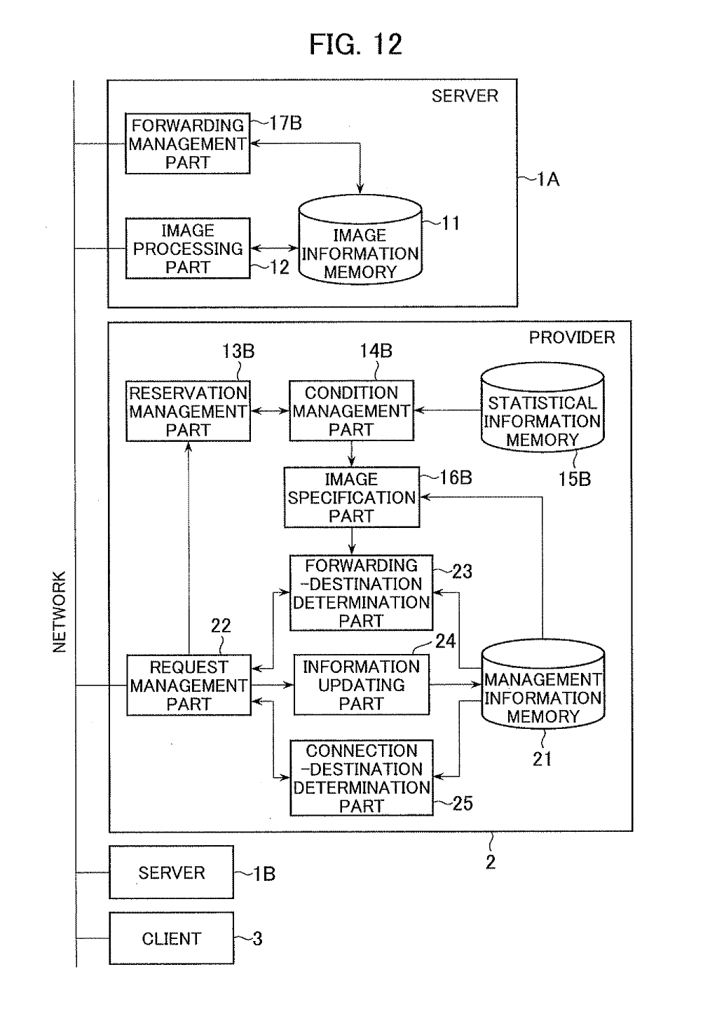

In the medical image management system according to the first embodiment, an example is described in which reservations for image processing are accepted in each server. In contrast, in a medical image management system according to a fourth embodiment, reservations for image processing for each server are collectively managed by a provider. The configuration of the medical image management system according to the present embodiment will be described with reference to FIG. 12, with a focus on configurations different from those of the medical image management system according to the first embodiment. FIG. 12 is a block diagram of the medical image management system according to the present embodiment.

In the medical image management system according to the first embodiment, each server includes the reservation management part 13, the condition management part 14, the statistical information memory 15, and the image specification part 16. In contrast, in the medical image management system according to the present embodiment, the provider 2 includes a reservation management part 13B, a condition management part 14B, a statistical information memory 15B, and an image specification part 16B.

Upon receiving reservation information for image processing from the client 3, the request management part 22 outputs the reservation information to the connection-destination determination part 25, and causes the connection-destination determination part 25 to specify a server capable of executing the image processing shown in the reservation information as the connection destination server. Operations of the connection-destination determination part 25 are similar to those of the first embodiment. Next, the request management part 22 outputs information indicating the connection destination server and the reservation information to the reservation management part 13B.

The reservation management part 13B associates the information indicating the connection destination server and the reservation information that have been received from the request management part 22. As a result, the reservation management part 13B accepts a reservation for image processing for the connection destination server. Alternatively, a storage area that stores the reservation information and the information indicating the connection destination server may be provided in the reservation management part 13B.

Upon accepting the reservation for image processing, the reservation management part 13B outputs the information indicating the connection destination server as well as processing information included in the reservation information to the condition management part 14B.

In accordance with the details of each image process to be executed by each server, the statistical information memory 15B preliminarily stores the required space for executing each process as statistical information for the image processing of each server.

Moreover, the management information memory 21 according to the present embodiment associates information for specifying each medical image with both information indicating the storage destination of that medical image as well as with the supplementary information of that medical image, and stores them as image-storage-destination information. Based on this supplementary information, the image specification part 16B specifies the forwarding images. Furthermore, it is sufficient for the management information memory 21 to store supplementary information necessary for specifying the forwarding images, and there is no need to store all of the supplementary information.

The condition management part 14B collates the information indicating the connection destination server and the processing information that have been received from the reservation management part 13B with the statistical information stored in the statistical information memory 15B. As a result, the condition management part 14B specifies the required space for executing the processing corresponding to the processing information by the connection destination server. The condition management part 14B outputs the information indicating the connection destination server and the obtained required space to the image specification part 16B.

The image specification part 16B collates the information indicating the connection destination server that has been received from the condition management part 14B with the management information stored in the management information memory 21, and specifies the free space in the connection destination server. The image specification part 16B compares the required space received from the condition management part 14B with the free space in the connection destination server. If the free space in the connection destination server does not meet the required space, the image specification part 16B specifies forwarding images to be forwarded from the connection destination server to another server. Operations of the image specification part 16B for specifying the forwarding images will be described in detail below.

The image specification part 16B first searches the image-storage-destination information stored in the management information memory 21, and extracts information on the medical images stored in the connection destination server. Moreover, the image specification part 16B searches the management information stored in the management information memory 21, and extracts information related to processing that the connection destination server is capable of executing. The image specification part 16B collates the supplementary information included in the information on the medical images stored in the connection destination server with the information related to processing that the connection destination server is capable of executing. As a result of this collation, the image specification part 16B specifies medical images that the connection destination server does not consider subjects for processing as forwarding images. Alternatively, as another example, the image specification part 16B may be operated to specify medical images that have not been updated for a fixed period as the forwarding images, based on the supplementary information. The image specification part 16B notifies the forwarding-destination determination part 23 of the specified forwarding images.

The forwarding-destination determination part 23 collates the supplementary information associated with the forwarding images specified by the image specification part 16B with information on each server that is included in the management information, and specifies the forwarding destination server. The processing for specifying the forwarding destination server is similar to that of the forwarding-destination determination part 23 according to the first embodiment. The forwarding-destination determination part 23 notifies the request management part 23 of the forwarding destination server specified based on the above collations together with the forwarding images.

Upon receiving the notification of the forwarding destination server and the forwarding images from the forwarding-destination determination part 23, the request management part 22 instructs the forwarding of the forwarding images to the connection destination server.

This forwarding instruction is received by the forwarding management part 17B of the connection destination server. Upon receiving this instruction, the forwarding management part 17B extracts the forwarding images in the notification from the image information memory 11, and forwards them to the forwarding destination server in the notification. When the forwarding of the forwarding images is complete, the forwarding management part 17B transmits information for specifying the forwarding images as well as information indicating the forwarding destination server to the provider 2, and sends a notification of the completion of forwarding. Furthermore, operations of the provider 2 after it receives this notification are similar to those of the provider 2 according to the first embodiment.

Moreover, after the completion of forwarding, the forwarding management part 17B deletes the forwarded forwarding images from the image information memory 11. Subsequently, the forwarding management part 17B calculates the free space in the image information memory 11. This calculation method is similar to the operation of the image specification part 16 according to the first embodiment. The forwarding management part 17B notifies the provider 2 of the information indicating the calculated free space. Here, operations of the provider 2 after it receives this notification are similar to the provider 2 according to the first embodiment.

Moreover, if it receives forwarding images from another server, the forwarding management part 17B stores these forwarding images in the image information memory 11. When the storage of the forwarding images in the image information memory 11 is complete, the forwarding management part 17B calculates the free space in the image information memory 11. The forwarding management part 17 notifies the provider 2 of the information indicating the calculated free space and sends a request for an update of the management information. Here, operations of the provider 2 after it receives this request are similar to the provider 2 according to the first embodiment.

### (Operations)

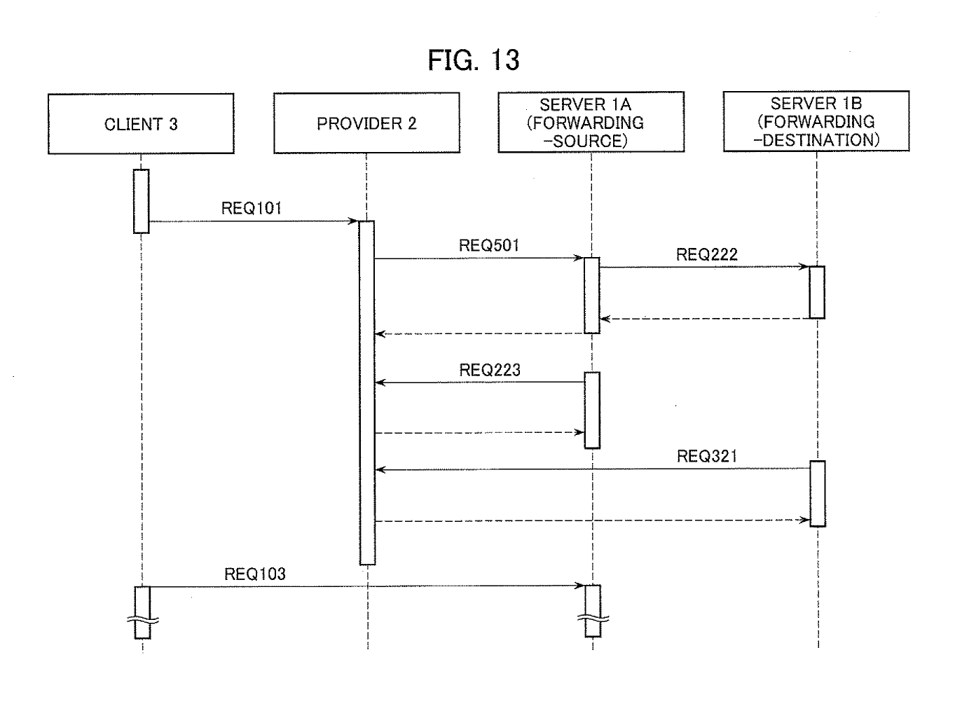

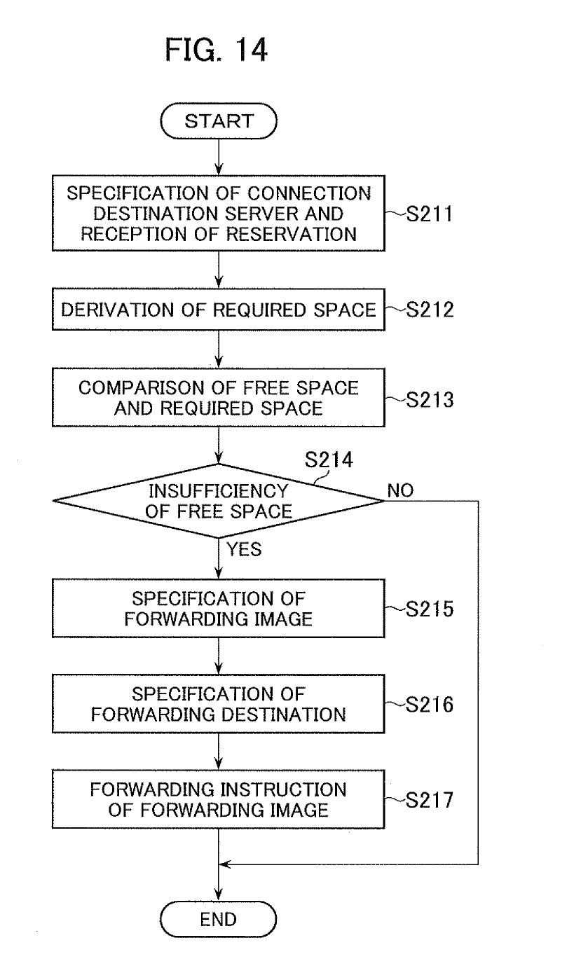

Next, a series of operations of the medical image management system according to the fourth embodiment will be described based on an example in which the server 1A accepts a reservation for image processing from the client 3, with reference to FIG. 13 and FIG. 14. FIG. 13 is a sequence diagram of the medical image management system according to the present embodiment. Moreover, FIG. 14 is a flowchart for describing operations of the provider 2 of the medical image management system according to the present embodiment.

First, reservation information (REQ101 in FIG. 13) including processing information indicating the details of image processing is transmitted from the client 3 to the request management part 22 of the provider 2.

### (Step S211)

Upon receiving the reservation information REQ101 from the client 3, the request management part 22 outputs the reservation information to the connection-destination determination part 25, and causes the connection-destination determination part 25 to specify a connection destination server capable of executing the image processing shown in the reservation information. For example, let us say that the application corresponding to the processing information in the reservation information REQ101 is the application AppX. In this case, based on the management information stored in the management information memory 21 (e.g., FIG. 3), the connection-destination determination part 25 specifies the server 1A, in which the application AppX has been installed, as the connection destination server. Next, the request management part 22 outputs information indicating the specified server 1A and the reservation information REQ101 to the reservation management part 13B.

The reservation management part 13B associates, manages and stores the information indicating the server 1A and the reservation information REQ101 that have been received from the request management part 22. As a result, the reservation management part 13B accepts a reservation for image processing for the server 1A.

### (Step S212)

Upon accepting the reservation for image processing, the reservation management part 13B outputs the information indicating the server 1A and the processing information included in the reservation information REQ 101 to the condition management part 14B. The condition management part 14B collates the information indicating the server 1A and the processing information that have been received from the reservation management part 13B with the statistical information stored in the statistical information memory 15B. As a result, the condition management part 14B specifies the required space for executing the processing corresponding to the processing information using the server 1A. For example, if the application AppX corresponding to the processing information is an application for cerebral blood flow analysis, the condition management part 14B specifies 200 MB as the required space, based on the statistical information (e.g., FIG. 2).

### (Step S213)

The condition management part 14B outputs the information indicating the server 1A, which is the connection destination, and the obtained required space to the image specification part 16B. The image specification part 16B collates the information indicating the server 1A that has been received from the condition management part 14B with the management information stored in the management information memory 21, and specifies information indicating the free space in the server 1A. The image specification part 16B compares the required space received from the condition management part 14B with the information indicating the free space in the server 1A.

### (Step S214)

If the required space for executing the processing corresponding to the processing information is less than the free space in the server 1A (Step S214: N), the server 1A ends the processing related to the acceptance of the reservation.

### (Step S215)

If the free space in the server 1A does not meet the required space (i.e., if the required space is larger than the free space) (Step S214: Y), the image specification part 16B specifies forwarding images from among the medical images stored in the server 1A. For example, let us say that the supplementary information of the forwarding images indicates that the private tags are “aaaabbbb”. In this case, based on the management information (e.g., FIG. 3), the forwarding-destination determination part 23 specifies the fact that the forwarding images are subject to the processing of the application AppZ. As a result, the forwarding-destination determination part 23 specifies the server 1B, in which the application AppZ has been installed, as the forwarding destination server. Furthermore, instead of private tags, the forwarding-destination determination part 23 may specify the forwarding destination server based on information indicating modalities or information indicating functions (i.e., types of partial image processing). The image specification part 16B notifies the forwarding-destination determination part 23 of the specified forwarding images.

### (Step S216)

The forwarding-destination determination part 23 collates the supplementary information associated with the forwarding images specified by the image specification part 16B with the information on each server that is included in the management information, and specifies the forwarding destination server. The forwarding-destination determination part 23 notifies the request management part 22 of the specified forwarding destination server together with the forwarding images. In the following description, server 1B has been identified as the forwarding destination server.

### (Step S217)

The request management part 22 instructs the forwarding of the forwarding images to the server 1B to the server 1A (REQ501 in FIG. 13). The instruction REQ501 related to the forwarding of the forwarding images is received by the forwarding management part 17B of the server 1A. The forwarding management part 17B extracts the forwarding images in the notification from the image information memory 11, and forwards them to the server 1B that is also in the notification (REQ222 in FIG. 13).

When the forwarding of the forwarding images is complete, the forwarding management part 17B of the server 1A transmits the information for specifying the forwarding images and the information indicating the server 1B to the provider 2, and sends a notification of the completion of forwarding. Moreover, after the completion of forwarding, the forwarding management part 17B of the server 1A deletes the forwarded forwarding images from the image information memory 11. Subsequently, the forwarding management part 17B calculates the free space in the image information memory 11. The forwarding management part 17B notifies the provider 2 of the information indicating the calculated free space. Furthermore, the above notification of the completion of forwarding to the provider 2 and the notification of the information indicating the free space correspond to REQ223 in FIG. 13.

Upon receiving the notification of the completion of forwarding from the server 1A, the request management part 22 outputs the information for specifying the forwarding images as well as the information indicating the forwarding destination server, which were also in the notification, to the information updating part 24, and instructs an update of the image-storage-destination information. Upon receiving this instruction, the information updating part 24 updates the information indicating the storage destination of the forwarding images that is included in the image-storage-destination information. As a result, the storage destination of the forwarding images that is included in the image-storage-destination information is updated from the server 1A to the server 1B, which is the forwarding destination server.

Moreover, upon receiving the notification of the information indicating the free space from the server 1A, the request management part 22 outputs the information indicating the server 1A and the notified information indicating the free space to the information updating part 24, and instructs an update of the management information. Upon receiving this instruction, the information updating part 24 updates the information indicating the free space in the server 1A that is included in the management information.

Moreover, the forwarding management part 17B of the server 1B causes the image information memory 11 to store the forwarding images received from the server 1A. When the storage of the forwarding images in the image information memory 11 is complete, the forwarding management part 17B of the server 1B calculates the free space in the image information memory 11. The forwarding management part 17 notifies the provider 2 of the information indicating the calculated free space (REQ321 in FIG. 13). Upon receiving this notification REQ321, the request management part 22 of the provider 2 outputs the information indicating the server 1B and the notified information indicating the free space to the information updating part 24, and instructs an update of the management information. Upon receiving this instruction, the information updating part 24 updates the notified information indicating the free space in the server that is included in the management information.

According to the medical image management system according to the present embodiment, it becomes possible to collectively manage reservations for image processing as well as processing related to the forwarding of images between servers as a result of such reservations using the provider 2. Moreover, as with the medical image management system according to the first embodiment, it becomes possible to prevent compression of storage area required for each server to execute processing, and to deter or mitigate the occurrence of waiting time during operations caused by forwarding data to secure space.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A medical image management system comprising:
a plurality of servers that each comprise a memory that stores medical images to which supplementary is attached, and that perform image processing on said medical images instructed by a client;
a determination means that determines whether or not to forward said medical images based on the free space required for said image processing and the free space in said memories of said servers;
a forwarding-destination determination part that determines a forwarding destination server to which the medical images are forwarded; and
a forwarding processing means that forwards said medical images used for said image processing to the server determined by said forwarding-destination determination part.

2. The medical image management system according to claim 1, further comprising:
a reservation management part that accepts reservation information indicating reservations for image processing for said medical images,
wherein said forwarding-destination determination part determines said forwarding destination server based on said reservation information.

3. The medical image management system according to claim 2, wherein
said reservation information includes at least one of the type of image processing for said medical images, the type of application, and the data type of said medical images, and
said forwarding-destination determination part determines said forwarding destination server based on this information.

4. The medical image management system according to claim 3, wherein said determination means determines said required free space based on at least one of the imaging conditions of said medical images, said type of image processing, said type of application, and said data type.

5. A medical image management system that includes a plurality of servers that each comprise a memory that stores medical images to which supplementary information is attached, and that executes image processing for said medical images instructed by a client using said servers, comprising:
a reservation management part that accepts, from said client, the details of the processing performed on said medical images and a reservation for that process;
a determination means that determines whether or not the free space in the memory of a first server, in which the execution of said processing is scheduled by said reservation, is less than a prescribed amount of free space; and
a forwarding processing means that, if it is determined by said determination means that the free space is smaller, forwards at least part of the images stored in said first server to a second server as forwarding images.

6. The medical image management system according to claim 5, further comprising:
a condition management part that specifies the space required in said memory for executing said processing for which said reservation management part has accepted a reservation as said prescribed space; and
a forwarding-destination determination part that, by collating the data volume of said forwarding images with the free space in each server, specifies said second server that is capable of storing said forwarding images from among said plurality of servers;
wherein said determination means specifies said forward images based on the supplementary information of each medical image stored in said memory of said first server, and causes said forwarding processing means to forward said forwarding images to said second server specified by said forwarding-destination determination part.

7. A medical image management system that includes a plurality of servers that each comprise: a memory that stores medical images to which supplementary information including data volume is attached; and a processing part that performs image processing on said medical images, and that executes a plurality sets of processing for said medical images instructed by a client by distributing said processing to said plurality of servers, comprising:
a reservation management part that accepts reservations for said processing by receiving reservation information including the details of processing to be performed on said medical images from said client;
a condition management part that specifies the space required in said memory for executing said processing for which said reservation management part has accepted a reservation;
a determination means that compares the free space in said memory of a server in which the execution of said processing is scheduled by said reservation with said required space, and if said free space is less than said required space, specifies forwarding images to be forwarded to other servers from among the medical images stored in said memory of said reserved server based on the supplementary information of each medical image stored in said memory of said reserved, server;
a management information memory that stores management information including information indicating the free space in the memory of each server;
a forwarding-destination determination part that receives the supplementary information of said forwarding images, and, by collating the data volume of said forwarding images that is included in the received supplementary information with said free space in each server that is included in said management information, specifies a forwarding destination server that is capable of storing said forwarding images from among said plurality of servers; and
a forwarding processing means that forwards said forwarding images to said forwarding destination server specified by said forwarding-destination determination part.

8. The medical image management system according to claim 7, wherein said condition management part stores statistical information including the space required for executing said processing in relation to the details of each of said processing, and, by collating the details of said processing that are included in said reservation information with said statistical information, specifies the space required in said memory for executing said processing.

9. The medical image management system according to claim 7, wherein
said reservation management part accepts said reservation information that, in addition to said processing details, includes information for specifying medical images to be processed; and
said determination means compares the free space in said memory of the server in which said medical images to be processed are stored with said required space.

10. The medical image management system according to claim 7, further comprising:
an imaging part that captures medical images, wherein
said reservation management part accepts reservation information for processing related to said image capture; and
said determination means compares the free space in said memory of said server including said imaging part, in which image capture is scheduled by said reservation information, with said required space.

11. The medical image management system according to claim 7, wherein
said supplementary information includes the data types of said forwarding images,
said management information includes the details of said processing that each server is capable of executing, and
said forwarding-destination determination part, by collating said data types included in the supplementary information with said processing details included in said management information, specifies a server from among said plurality of servers that is capable of processing said forwarding images to which this supplementary information is attached as said forwarding destination server.

12. The medical image management system according to claim 7, wherein
regardless of the presence or absence of a reservation, if new images are created as secondary images as a result of performing image processing on said medical images, said processing part specifies said secondary images as said forwarding images, and
said forwarding processing means forwards said forwarding images to said forwarding destination server specified by said forwarding-destination determination part.

13. The medical image management system according to claim 12, wherein
said supplementary information includes the data types of said forwarding images,
said management information includes the details of said processing that each server is capable of executing, and
said forwarding-destination determination part, by collating said data types included in the supplementary information with said processing details included in said management information, specifies a server from among said plurality of servers that is capable of processing said forwarding images to which this supplementary information is attached as said forwarding destination server.

14. The medical image management system according to claim 13, wherein said processing part, by collating the details of processes that it is capable of executing with said data types included in the supplementary information of said secondary images, determines whether or not said secondary images are subject to processing, and if said processing that it is capable of executing do not include said secondary images as subjects for processing, specifies said secondary images as said forwarding images.

15. A medical image management system that includes a plurality of servers that each comprise: a memory that stores medical images to which supplementary information including data volume is attached; and a processing part that performs images processing on said medical images, and that executes a plurality sets of processing for said medical images instructed by a client by distributing said processing to said plurality of servers, comprising:
a management information memory that stores management information including at least information indicating the free space in the memory of each server;
a forwarding-destination determination part that receives the supplementary information of said medical images, and by collating the data volume of said medical images that is included in this supplementary information with said free space in each server that is included in said management information, specifies said server that is capable of storing said medical images as a forwarding destination server for the medical images; and
a forwarding processing means that forwards said medical images to said forwarding destination server specified by said forwarding-destination determination part,
wherein if said processing part creates new medical images as secondary images as a result of performing images processing on said medical images, said forwarding processing means forwards said secondary images.

16. The medical image management system according to claim 15, wherein
said supplementary information further includes information for specifying the data types of said medical images,
said processing part, by collating the details of said process that it is capable of executing with said data types included in the supplementary information of said secondary images, specifies said secondary images as said forwarding images if it is unable to perform image processing on said secondary images,
said management information memory further preliminarily stores the details of said processing that each server is capable of executing as management information, and
said forwarding-destination determination part, by collating said data types included in the supplementary information with said processing details included in said management information, further specifies a server from among said plurality of servers that is capable of processing said medical images to which this supplementary information is attached as said forwarding destination server.

17. A medical image management device connected to a medical image management system that includes a plurality of servers that each comprise: a memory that stores medical images to which supplementary information including data volume and data type is attached; and a processing part that performs image processing on said medical images, and that executes a plurality sets of processing for said medical images instructed by a client by distributing said processing to said plurality of servers, comprising:
a management information memory that stores the free space in each server and said processes that each server is capable of executing as management information; and
a forwarding-destination determination part that receives the supplementary information of said medical images, and by collating this supplementary information with said management information, specifies a forwarding destination server, from among said plurality of servers, capable of storing and processing said medical images to which this supplementary information is attached.
